(19) United States
(12) Patent Application Publication
(10) Pub. No.: US 2026/0195147 A1
(43) Pub. Date: Jul. 9, 2026

(54) SYSTEM, METHOD, AND COMPUTER PROGRAM FOR DYNAMIC RENDERING OF UI COMPONENTS

(71) Applicant: Rakuten Group, Inc., Tokyo (JP)

(72) Inventors: Armando Hernandez, Foster City, CA (US); Ashok Chikkam, Foster City, CA (US); Devendra Dinesh Vaja, San Mateo, CA (US); Giuliano Manno, San Francisco, CA (US); Sundar Krishnamurthy, Saratoga, CA (US); Victor Arthur Nazareth, Redwood City, CA (US)

(21) Appl. No.: 19/012,739

(22) Filed: Jan. 7, 2025

(51) Int. Cl. G06F 9/451; G06F 3/0481; G06F 40/109

(52) U.S. Cl. CPC G06F 9/451; G06F 3/0481; G06F 40/109

(57) ABSTRACT

A system, method, and computer program for dynamically rendering user interface (UI) components without requiring code changes are provided. A server receives layout specifications and a UI design for a UI component, extracts layout and UI metadata, and publishes the metadata with a timestamp to a cloud-based repository accessible by client applications. The client applications periodically check for updated metadata and, if newer metadata is found, download it to their local repositories. When a client application receives a page feed referencing a UI component, the application's rendering engine dynamically renders the component using the locally stored metadata. Because the UI component presentation is driven by metadata rather than static code, changes made at the design level are instantly reflected in the client applications, significantly reducing development overhead and deployment time.

### BACKGROUND OF THE INVENTION

### 1. Field of the Invention

The present disclosure relates generally to the field of user interface (UI) design and rendering, and, more specifically, to dynamically rendering UI components in a client application by providing UI and layout metadata to a repository accessible to the client application, thereby enabling UI updates without changing underlying client code.

### 2. Description of the Background Art

User interfaces (UI) for web applications, mobile applications, and other digital platforms typically include a variety of UI components. The visual appearance and layout of these UI components are commonly designed using specialized design systems or tools (e.g., FIGMA). Once a designer finalizes a UI component's appearance, a development team traditionally translates the designed component into code for a client application that defines how the UI component is to be rendered on one or more client platforms, such as a web browser, an iOS application, or an Android application. This code is referred to as “static rendering code.”

In conventional processes, the designer's work product serves primarily as a reference from which developers create the static rendering code. This code typically includes fixed style definitions, layout constraints, and platform-specific implementation details. Once created, the static rendering code is integrated into the client application. The integration process involves multiple steps, including code approval, quality assurance (QA) testing, and platform-specific validation. Changes to the design of a UI component require corresponding modifications to the static rendering code. Each time a change is made, the code review, testing, and release processes must be repeated. These dependencies render even minor updates to UI elements time-consuming, costly, and prone to errors.

Various systems and tools exist that can automate some portions of the coding process. For instance, some prior art solutions are capable of taking a designer's UI component and automatically generating the static rendering code needed to implement that component in a client application. While such automation reduces the amount of manual coding, the process still requires the production and distribution of static rendering code. This generated code must be tested, validated, and, when changes occur, updated and re-approved. Thus, automated code generation techniques do not fundamentally eliminate the overhead and complexity associated with the traditional code-based UI design-to-deployment cycle.

The solution set forth in the present disclosure overcomes the above-described limitations by introducing a novel approach that leverages metadata to dynamically render UI components. Unlike the prior art, the solution described herein enables real-time updates to UI components without modifying the client application code. By dynamically rendering UI components based on metadata, the solution eliminates redundant coding processes and significantly accelerates the iteration cycle.

### SUMMARY OF THE DISCLOSURE

The present disclosure relates to a method, system, and computer program for enabling the dynamic rendering of user interface components using UI and layout metadata stored in a cloud-based repository. A server receives layout specifications and a UI design for a UI component from a designer. The layout specifications specify layout parameters for one or more screen sizes, and the UI design specifies style attributes for the component. The server extracts layout metadata and UI metadata from these inputs and publishes them to a repository along with a timestamp.

Client applications periodically check the repository for updated metadata. If updated metadata is found, the client applications download it, thereby updating their local repositories without changing or redeploying client code. When a client application receives a feed for a page containing a referenced UI component, it dynamically renders the component using a rendering engine and the locally stored metadata. Because the rendering is driven by metadata rather than embedded static rendering code, changes made by the designer to UI elements become immediately available across client platforms, streamlining the design-to-deployment process.

In one embodiment, a method for dynamic rendering of user interface components in a client application comprises the following steps:
receiving, at a server, layout specifications and a UI design for a UI component from a designer, wherein the layout specifications specify layout parameters for one or more screen sizes;
extracting, by the server, layout metadata for the UI component from the layout specifications;
extracting, by the server, UI metadata from the UI design, wherein the UI metadata includes style attributes for the UI component;
publishing, by the server, the UI metadata and the layout metadata to a cloud repository along with an associated timestamp, wherein:
the published metadata is accessible to client applications that render pages with the UI component;
if either the UI design or the layout specifications is subsequently updated, the server updates the corresponding metadata in the cloud repository and associates the UI and layout metadata in the cloud repository with a new timestamp; and
periodically checking, by a client application, the cloud repository for the latest UI metadata and layout metadata by comparing the timestamp of the UI and layout metadata in the cloud repository with a timestamp of local UI and layout metadata in a local repository of the client application;
in response to the cloud repository timestamp being newer updating, by the client application, the local UI metadata, local layout metadata, and associated local timestamp by downloading the latest UI metadata, layout metadata, and associated timestamp from the cloud repository;
receiving, at the client application, a feed for a page that includes the UI component; and
dynamically rendering the UI component using a rendering engine within the client application based on the UI and layout metadata stored in the local repository, wherein the client application can render UI components created or changed after the client application was built without requiring changes to the client application code as a result of downloading the latest UI and layout metadata for the UI components from the cloud repository.

### BRIEF DESCRIPTION OF THE DRAWINGS

FIG. 1 is a block diagram that illustrates an example system architecture, according to one embodiment, for dynamic rendering of UI components.

FIG. 2 is a flowchart that illustrates a method for extracting and publishing UI and layout metadata according to one embodiment.

FIG. 3 is a flowchart that illustrates a client application metadata update process according to one embodiment.

FIG. 4 is a flowchart that illustrates a client dynamic UI rendering process according to one embodiment.

### DETAILED DESCRIPTION OF THE PREFERRED EMBODIMENTS

The present disclosure relates to a system, method, and computer program for dynamic rendering of UI components in a client application by leveraging metadata extracted from a UI design. The method is performed by a computer system that includes a server, a cloud repository for UI and layout metadata, and client applications.

Terms

As used herein, the term “UI design” refers to a visual representation of one or more user interface components that a designer creates using a design tool (e.g., FIGMA or a similar application), AI, or other suitable means. The UI design captures the stylistic and visual aspects of the user interface component, including, but not limited to, color schemes, fonts, spacing, effects (such as shadows or gradients), and other graphical attributes. The “designer” may be a human, an AI agent, or an AI model.

As used herein, the term “layout specification” refers to a set of parameters or rules that define how a user interface component should be arranged, sized, or positioned in one or more display contexts. The layout specification may specify, for example, the dimensions (width, height), minimum and maximum sizing constraints, relative positioning rules, margins, padding, responsive breakpoints for different screen sizes (e.g., mobile, tablet, desktop), and how the component should adapt to various device orientations. A layout specification may include instructions for flexible or responsive layouts, ensuring that the component's presentation can scale or adjust gracefully as the display environment changes.

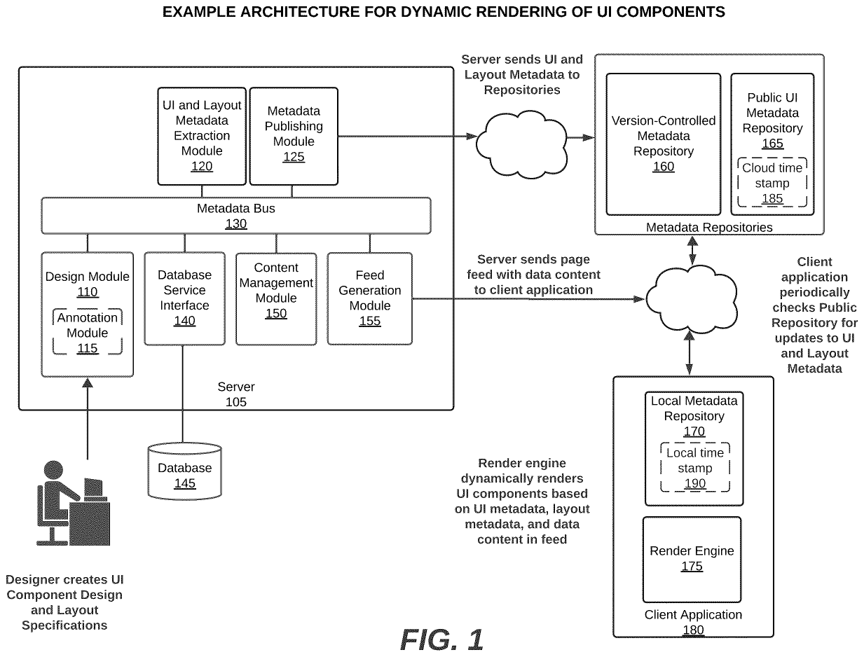

### System Overview (FIG. 1)

FIG. 1 illustrates an example system architecture for dynamic rendering of UI component. The figure highlights how UI and layout metadata flow from the design stage to the client application, enabling real-time updates without requiring changes to client code.

The system includes a server (105) that receives layout specifications and UI designs from designers and extracts layout and UI metadata. The server includes the following modules:
A Design Module (110) that receives UI component designs, as well as layout specifications, from a designer, typically produced using a design tool such as FIGMA.
A UI Metadata Extraction Module (120) that processes the UI component design and layout specifications to identify and extract UI and layout metadata.
A Metadata Publishing Module (125) that packages extracted UI metadata and layout metadata, associates them with a timestamp, and prepares them for publication to the metadata repositories.
A Metadata Bus (130) that provides an internal communication pathway that facilitates the transfer of extracted metadata between server modules.
A Feed Generation Module (155) generates and transmits page feeds to client applications. A page feed specifies the UI components that are in a UI page and uses a “template ID” to reference each unique UI component design. The page feed also includes any data from database (145) that is included in the UI page.

The server (105) may also include several modules that are not necessary for the subject matter of this disclosure, but are disclosed herein for further context of how the methods disclosed herein fit into overall UI page creation:
An Annotation Module (115) that enables a user to annotate UI components with data attributes that can be mapped to database fields in database 145 using a mapper module (not shown). In one embodiment, the Annotation Module is a plug-in to the Design Module.
A Database (145) and Database Service Interface (140) that store and retrieve additional data or content that may be associated with the UI components.
A Content Management Module (150) that enables a UI page developer to add UI components to a frontend page feed and, if applicable, to associate the mapped UI components with instances of the database objects.

An example of the Annotation Module (115), Database (145), Database Service Interface (140), and Content Management Module (150) are described in U.S. patent application Ser. No. 17/679,238 titled “System, Method, and Computer Program for Providing an End-to-End Solution for Front End Page Generation,” and filed on Feb. 24, 2022, the contents of which are incorporated by reference as if fully disclosed herein.

The system includes the following metadata repositories:
a Version-Controlled Metadata Repository (160) that stores and maintains version histories of UI and layout metadata. It enables tracking changes over time and rolling back to previous versions if necessary.
A Public UI Metadata Repository (165) that provides client applications with a cloud-based source of the most up-to-date UI and layout metadata. Each entry includes a timestamp (185) that indicates the recency of the metadata. Client applications access this repository to check if newer metadata versions are available.

The system includes client applications (180), and each client application includes the following:
A Local Metadata Repository (170) that stores previously retrieved UI and layout metadata, as well as a local timestamp (190).
A Rendering Engine (175) that dynamically renders UI components on the client side using the locally stored metadata.

When the client application starts or periodically checks for updates, it compares the local timestamp against the repository's timestamp and, if newer metadata exists, downloads and updates its local metadata. By relying on metadata rather than static rendering code, the client application can display updated or entirely new UI components without requiring code changes, thereby streamlining the update and deployment process.

Together, these components enable designers to update UI appearances simply by changing UI and layout metadata at the server level, allowing client applications to incorporate these updates automatically, thus improving efficiency and reducing the need for frequent code releases.

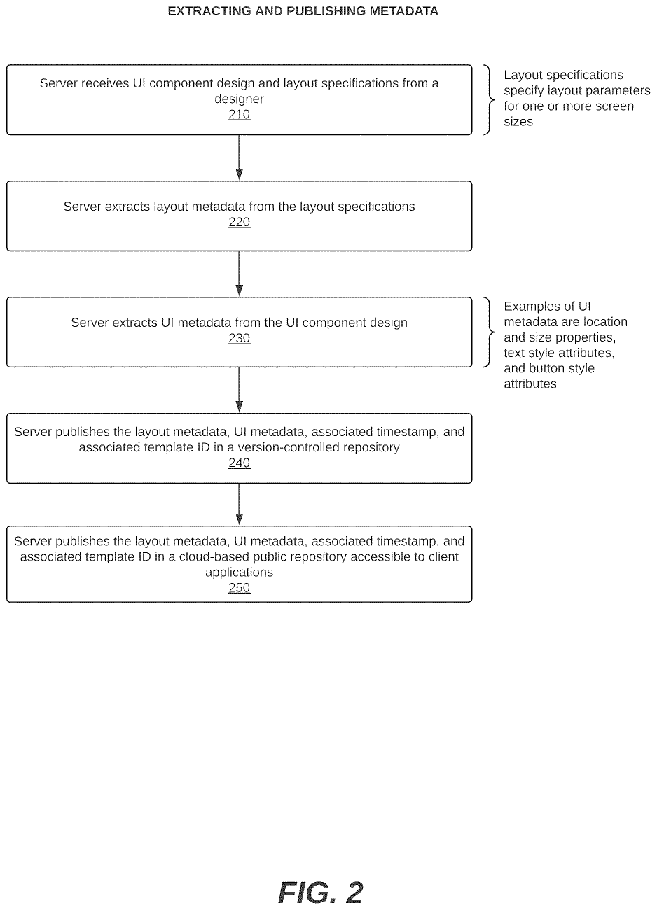

### Extracting and Publishing Metadata (FIG. 2)

FIG. 2 illustrates a method for extracting and publishing UI and layout metadata. The server receives a UI component design and layout specifications from a designer (210). The server extracts layout metadata from the layout specifications (step 220) and UI metadata from the UI component design (step 230). The layout specifications may include parameters for various screen sizes, such as mobile and desktop layouts, minimum/maximum dimensions, or responsive breakpoints. The UI component design provides visual attributes, such as text style (e.g., line height, letter spacing, color, typeface, effects, font size, font weight, text alignment, text case, line truncation, and shadow), and styling for buttons, icons, images, text-entry boxes, videos, cards, tags, toggle buttons, and/or dividers (e.g., padding, text line height, text spacing, color, font, effects), and these visual attributes are part of the UI metadata. UI metadata may also include general location and size properties.

The combined UI and layout metadata for the UI component, along with a timestamp and a template ID (which uniquely identifies the component design), is published to a version-controlled repository (240). This allows the system to track changes to the metadata over time, providing a historical record of design updates. In addition to storing the metadata in the version-controlled repository, the server also publishes the metadata and associated timestamp to a public, cloud-based repository accessible to client applications (250). This public repository acts as a central source of truth for the most recent UI and layout metadata, allowing clients to fetch updates as needed.

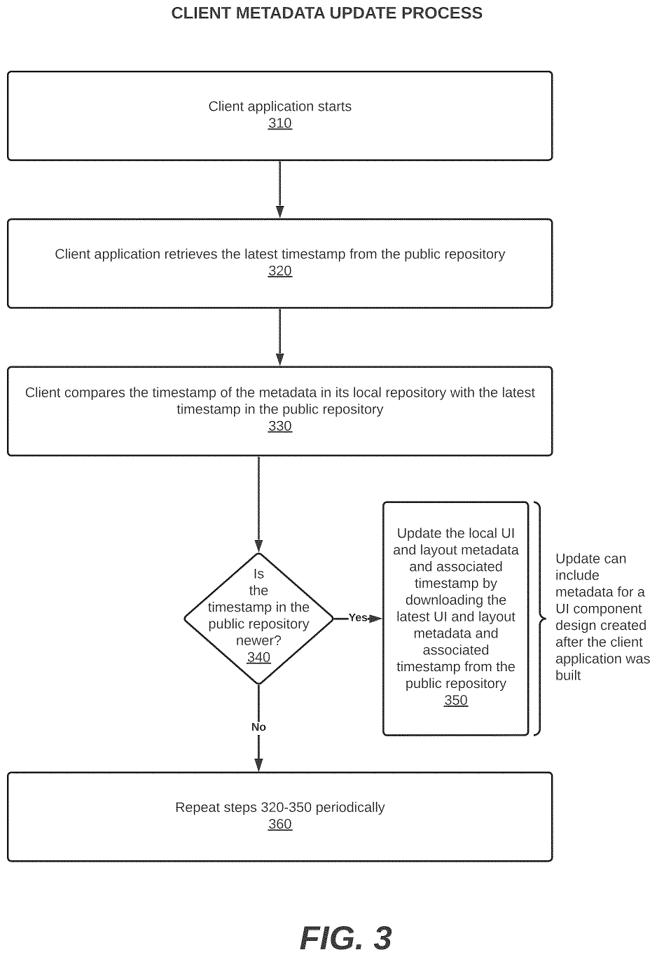

### Client Metadata Update Process (FIG. 3)

FIG. 3 illustrates a client metadata update process. When a client application starts up (step 310), it retrieves the latest timestamp from the public repository to determine if metadata updates are available (320). The client application compares this latest timestamp with its locally stored timestamp in the local metadata repository (330). If the public repository's timestamp is newer (step 340), it indicates that the server has published updated UI and/or layout metadata, reflecting recent design changes by the designer. In such a case, the client application downloads the updated metadata, including UI attributes (such as colors, fonts, and effects for text or buttons) and layout parameters (such as responsive breakpoints and positioning rules), and stores them in the local metadata repository along with the new timestamp (350). If the public timestamp is not newer, the client application retains its current metadata. This comparison and update process is repeated periodically (step 360), ensuring that even after the client application was initially built and deployed, it remains synchronized with the latest design specifications at all times.

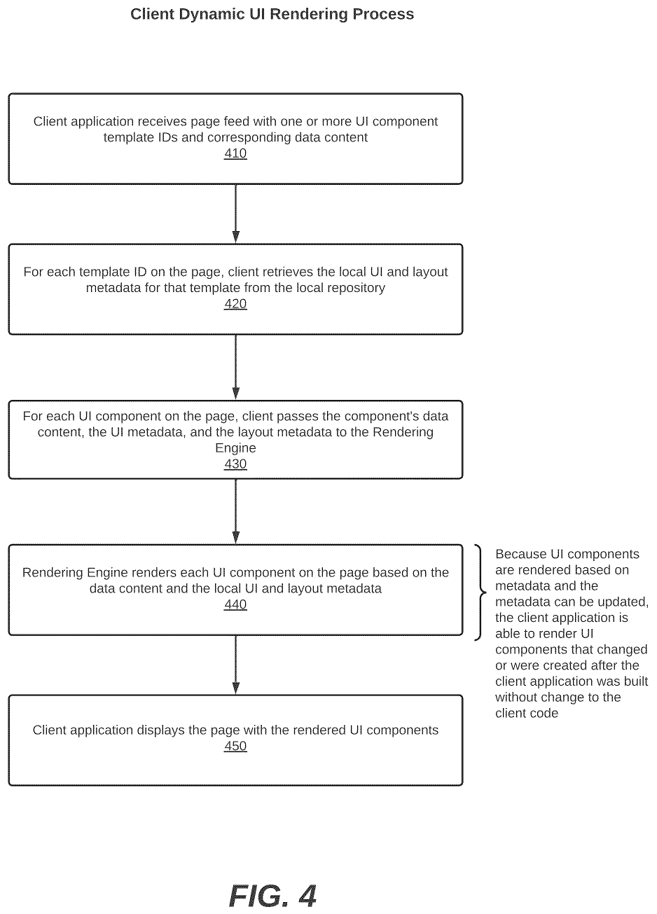

### Client Dynamic UI Rendering Process (FIG. 4)

FIG. 4 illustrates a client dynamic UI rendering process. The client application receives a page feed from the server that includes one or more UI components, referenced using template IDs (410). The page feed may also include associated data content, which may be injected into UI components as described in U.S. patent application Ser. No. 17/679,238, incorporated by reference herein. For each referenced UI component in the page feed, the client application retrieves the corresponding UI and layout metadata from its local metadata repository (420). Because this metadata is periodically updated, it may reflect design modifications made after the client application was originally deployed. The client application then passes the retrieved UI metadata, layout metadata, and any associated data content (e.g., text strings, images, or database-driven values) to the rendering engine (430). The rendering engine interprets the metadata and assembles the UI component accordingly (also including any associated data content). For example, if the UI component includes text elements, the rendering engine applies the specified font, spacing, color, and effects. For button elements, the rendering engine uses the defined padding, text style, line height, text spacing, and effects to ensure that the button visually matches the most recent design.

The rendering engine dynamically renders the UI component on the page using this metadata-driven approach (440). Because the rendering is driven by metadata instead of hard-coded style attributes within the client application's compiled code, the client application can reflect newly created or updated UI components automatically. The page is then displayed to the user with the dynamically rendered UI component that incorporates the latest design updates (450).

### General

The methods described with respect to FIGS. 1-4 are embodied in software and performed by a computer system (comprising one or more computing devices) executing the software. A person skilled in the art would understand that a computer system has one or more memory units, disks, or other physical, computer-readable storage media for storing software instructions, as well as one or more processors for executing the software instructions.

As will be understood by those familiar with the art, the invention may be embodied in other specific forms without departing from the spirit or essential characteristics thereof. Accordingly, the above disclosure is intended to be illustrative, but not limiting, of the scope of the invention, which is set forth in the following claims.

1. A method, performed by a computer system, for dynamic rendering of user interface (UI) components in a client application, the method comprising:
receiving, at a server, layout specifications and a UI design for a UI component from a designer, wherein the layout specifications specify layout parameters for one or more screen sizes;
extracting, by the server, layout metadata for the UI component from the layout specifications;
extracting, by the server, UI metadata from the UI design, wherein the UI metadata includes style attributes for the UI component;
publishing, by the server, the UI metadata and the layout metadata to a cloud repository along with an associated timestamp, wherein:
the published metadata is accessible to client applications that render pages with the UI component;
if either the UI design or the layout specifications is subsequently updated, the server updates the corresponding metadata in the cloud repository and associates the UI and layout metadata in the cloud repository with a new timestamp; and
periodically checking, by a client application, the cloud repository for the latest UI metadata and layout metadata by comparing the timestamp of the UI and layout metadata in the cloud repository with a timestamp of local UI and layout metadata in a local repository of the client application;
in response to the cloud repository timestamp being newer updating, by the client application, the local UI metadata, local layout metadata, and associated local timestamp by downloading the latest UI metadata, layout metadata, and associated timestamp from the cloud repository;
receiving, at the client application, a feed for a page that includes the UI component; and
dynamically rendering the UI component using a rendering engine within the client application based on the UI and layout metadata stored in the local repository, wherein the client application can render UI components created or changed after the client application was built without requiring changes to the client application code as a result of downloading the latest UI and layout metadata for the UI components from the cloud repository.

2. The method of claim 1, wherein:
the feed for the page also includes data content for the UI component; and
the UI component is rendered using the data content and the UI and layout metadata in the local repository.

3. The method of claim 1, wherein the UI metadata includes location and size attributes of the UI component and style attributes for sub-elements within the UI component.

4. The method of claim 3, wherein a sub-element within the UI component is text and the style attributes for the text include one or more of the following: line height, letter spacing, color, typeface, effects, font size, font weight, text alignment, text case, line truncation, and shadow.

5. The method of claim 3, wherein a sub-element within the UI component is a button, icon, image, text-entry box, video, card, tag, or a divider and wherein the style attributes include one or more of the following: padding, text style, line height, text spacing, color, font, and effects.

6. The method of claim 1, wherein the UI metadata and the layout metadata are also stored in a second, version-control repository that tracks UI and layout metadata versions.

7. A system for dynamically rendering user interface (UI) component, comprising:
a server configured to:
receive layout specifications and a UI design for a UI component design from a designer, wherein the layout specifications specify layout parameters for one or more screen sizes;
extract layout metadata for the UI component from the layout specifications;
extract UI metadata for the UI component from the UI design, wherein the UI metadata specifies style attributes for the UI component;
publish the UI metadata and the layout metadata to a cloud repository along with an associated timestamp, wherein the published metadata is accessible to client applications that render pages with the UI component;
in response to receiving an update to the UI design or the layout specifications at the server, update the corresponding metadata in the cloud repository and associate the UI and layout metadata in the cloud repository with a new timestamp; and
a client application configured to:
periodically check the cloud repository for the latest UI metadata and layout metadata by comparing the timestamp of the UI and layout metadata in the cloud repository with a timestamp of local UI and layout metadata in a local repository of the client application;
in response to the cloud repository timestamp being newer, update the local UI metadata, layout metadata, and associated timestamp by downloading the latest UI metadata, layout metadata, and associated timestamp from the cloud repository;
receive a feed for a page that includes the UI component; and
dynamically rendering the UI component using a rendering engine within the client application based on the UI and layout metadata stored in the local repository, wherein the client application can render UI components created or changed after the client application was built without requiring changes to the client application code as a result of downloading the latest UI and layout metadata for the UI components from the cloud repository.

8. The system of claim 7, wherein the client application comprises a rendering engine that performs the dynamic rendering of UI components.

9. The system of claim 8, wherein:
the feed for a page also includes data content for the UI component; and
the rendering engine is configured to render the UI component using the data content and the UI and layout metadata in the local repository.

10. The system of claim 7, wherein the UI metadata includes location and size attributes of the UI component and style attributes for sub-elements within the UI component.

11. The system of claim 10, wherein a sub-element within the UI component is text and the style attributes for the text include one or more of the following: line height, letter spacing, color, typeface, effects, font size, font weight, text alignment, text case, line truncation, and shadow.

12. The system of claim 10, wherein a sub-element within the UI component is a button, icon, image, text-entry box, video, card, tag, or a divider and wherein the style attributes include one or more of the following: padding, text style, line height, text spacing, color, font, and effects.

13. The system of claim 7, wherein the UI metadata and the layout metadata are also stored in a second, version-control repository that tracks UI and layout metadata versions.

14. A non-transitory computer-readable medium storing instruction that, when executed by a computer system comprising a server and a client application, causes the computer system to perform the following method for dynamic rendering of user interface (UI) components in a client application, the method comprising:
receiving, at a server, layout specifications and a UI design for a UI component from a designer, wherein the layout specifications specify layout parameters for one or more screen sizes;
extracting, by the server, layout metadata for the UI component from the layout specifications;
extracting, by the server, UI metadata for the UI component from the UI design, wherein the UI metadata includes style attributes for the UI component;
publishing, by the server, the UI metadata and the layout metadata to a cloud repository along with an associated timestamp, wherein:
the published metadata is accessible to client applications that render pages with the UI component;
if either the UI design or the layout specifications is subsequently updated, the server updates the corresponding metadata in the cloud repository and associates the UI and layout metadata in the cloud repository with a new timestamp; and
periodically checking, by a client application, the cloud repository for the latest UI metadata and layout metadata by comparing the timestamp of the UI and layout metadata in the cloud repository with a timestamp of local UI and layout metadata in a local repository of the client application;
in response to the cloud repository timestamp being newer updating, by the client application, the local UI metadata, local layout metadata, and associated local timestamp by downloading the latest UI metadata, layout metadata, and associated timestamp from the cloud repository;
receiving, at the client application, a feed for a page that includes the UI component; and
dynamically rendering the UI component using a rendering engine within the client application based on the UI and layout metadata stored in the local repository, wherein the client application can render UI components created or changed after the client application was built without requiring changes to the client application code as a result of downloading the latest UI and layout metadata for the UI components from the cloud repository.

15. The non-transitory computer-readable medium of claim 14, wherein:
the feed for the page also includes data content for the UI component; and
the UI component is rendered using the data content and the UI and layout metadata in the local repository.

16. The non-transitory computer-readable medium of claim 14, wherein the UI metadata includes location and size attributes of the UI components and style attributes for sub-elements within the UI component.

17. The non-transitory computer-readable medium of claim 16, wherein a sub-element within the UI component is text and the style attributes for the text includes one or more of the following: line height, letter spacing, color, typeface, effects, font size, font weight, text alignment, text case, line truncation, and shadow.

18. The non-transitory computer-readable medium of claim 16, wherein a sub-element within the UI component is a button, icon, image, text-entry box, video, card, tag, or a divider and wherein the style attributes include one or more of the following:
padding, text style, line height, text spacing, color, font, and effects.

19. The non-transitory computer-readable medium of claim 14, wherein the UI metadata and the layout metadata are also stored in a second, version-control repository that tracks UI and layout metadata versions.
